(19) United States
(12) Patent Application Publication
(10) Pub. No.: US 2026/0317190 A1
(43) Pub. Date: Oct. 15, 2026

(54) A METHOD FOR PRODUCING AN ALUMINOUS MATERIAL

(71) Applicant: LAVA BLUE LTD, Manuka (AU)

(72) Inventors: Cameron JOHNSTON, Manuka (AU); Rachel PEPPER, Manuka (AU); Wayde MARTENS, Manuka (AU); Sara COUPERTHWAITE, Manuka (AU)

(21) Appl. No.: 19/116,623

(22) PCT Filed: Sep. 28, 2023
(86) PCT No.: PCT/AU2023/050939

§ 371 Date: Mar. 28, 2025

(30) Foreign Application Priority Data
Sep. 29, 2022 (AU) 2022902817

(51) Int. Cl. C01F 7/56; C01F 7/306; C22B 1/24; C22B 3/10; C22B 3/44; C22B 7/00; C22B 7/02; C22B 21/00

(52) U.S. Cl. CPC C01F 7/56; C01F 7/306; C22B 1/24; C22B 3/10; C22B 3/44; C22B 7/007; C22B 7/02; C22B 21/0023

(57) ABSTRACT

The present invention relates to a method for producing an aluminous material from an aluminium-containing material, in particular a solid waste obtained from the combustion of coal. The method comprises providing an aluminium-containing feedstock and subjecting the feedstock to an alkali fusion process to activate the feedstock. The activated feedstock is digested with hydrochloric acid to obtain a leachate. The leachate is separated to provide a pregnant liquor which is subjected to a sodium reduction process. The reduced sodium pregnant liquor is subjected to a crystallisation process to form aluminium chloride hexahydrate crystals.

### TECHNICAL FIELD

The present invention relates to a method for producing an aluminous material from an aluminium-containing material. In particular, the present invention relates to a method for producing an aluminous material from a solid waste obtained from the combustion of coal.

### BACKGROUND

Aluminium is a useful material which can be used to provide strong and lightweight metal alloys which are resistant to rusting. Aluminium is traditionally extracted from aluminium-containing ores such as bauxite or recovered from the recycling of aluminium scrap metal. However, industrial waste materials and solid waste residue from the combustion of coal (such as fly ash, boiler ash, red mud, dross, production line scrap, coal bottom ash, boiler slag, municipal incinerator bottom ash, or the like) may also contain commercially viable levels of aluminium.

Fly ash or flue ash is a waste material generated during the combustion of organic materials, such as coal, and refers to the fine particulate material captured from flue gases. Fly ash typically comprises minerals such as silicon dioxides, aluminium oxides, calcium oxides and iron oxides and may also contain trace amounts of other elements including rare earth elements. Fly ash typically comprises around 5-35% aluminium content, depending on the origin of the material being combusted as well as the power plant mode of operation. However, liberation of aluminium from fly ash is often difficult due to the nature of the aluminium oxides.

However, the prior art is replete with problems. Typically, these methods are generally conducted at elevated temperatures or pressures and consequently are energy intensive. For example, limestone and sodium carbonate sintering processes may be used to produce alumina by calcining the limestone-fly ash mixture or sodium carbonate-fly ash mixture at temperatures above 1,300° C. In addition, these sintering processes produce high quantities of waste slag.

Further, direct acid or caustic leaching processes often result in generation of leachates having high levels of impurities which require additional processing steps to purify the leachate. However, acid leaching processes often solubilise iron as well as aluminium requiring additional solubilisation and precipitation steps or use of magnetic separation. Caustic leaching processes may result in high levels of sodium in the leachate which prevents the purification of aluminium chlorides or reduces the yield.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method for producing an aluminous material, which may at least partially address one or more of the problems or deficiencies mentioned above or which may provide the public with a useful or commercial choice.

As used herein, the term “alkali fusion” is intended to refer to a method of heating an ore or other source of minerals with an alkali or alkaline earth reagent at an elevated temperature to render the mineral amenable to further treatment.

With the foregoing in view, the present invention in one form, resides broadly in a method for producing an aluminous material including:
providing an aluminium-containing feedstock;
subjecting the aluminium-containing feedstock to an alkali fusion process to generate an activated aluminium-containing feedstock;
contacting the activated aluminium-containing feedstock with a hydrochloric acid to obtain a leachate;
separating the leachate to generate a pregnant liquor;
subjecting the pregnant liquor to a sodium reduction process, the sodium reduction process including:
   adjusting a pH of the pregnant liquor to precipitate an aluminium hydroxide; separating the precipitated aluminium hydroxide from a spent liquor; and
   contacting the precipitated aluminium hydroxide with hydrochloric acid to provide a reduced-sodium pregnant liquor,
subjecting the reduced-sodium pregnant liquor to a crystallisation process to form an aluminium chloride hexahydrate crystals slurry, and
separating the aluminium chloride hexahydrate crystals slurry to obtain aluminium chloride hexahydrate crystals.

Advantageously, the method of the present invention enables the production of relatively high purity aluminium chloride hexahydrate from an aluminium-containing waste material comprising high sodium content. By “relatively high purity” aluminium chloride hexahydrate, it is envisaged that the aluminium chloride hexahydrate may contain less than 10% w/w of impurities. More preferably, the aluminium chloride hexahydrate may contain less than 5% w/w of impurities. More preferably, the aluminium chloride hexahydrate may contain less than 2.5% w/w impurities. More preferably, the aluminium chloride hexahydrate may contain less than 1% w/w impurities. More preferably, the aluminium chloride hexahydrate may contain less than 0.1% w/w impurities. In addition, the method of the present invention proceeds at a lower caustic fusion temperature compared to other alkali or alkali metal reagents. The method of the present invention has improved cost efficiencies and reduced complexity compared to traditional aluminium extraction processes as it does not require ion exchange, solvent extraction, or magnetic separation unit operations/

As indicated, an aluminium-containing feedstock may be provided.

Any suitable type of aluminium-containing feedstock may be used.

In some embodiments, the aluminium-containing feedstock may be a solid material. Any suitable solid material may be used, such as a waste residue from combustion of coal or other organic material, or an incinerator waste. For instance, the aluminium-containing feedstock may be fly ash, boiler ash, boiler slag, bottom ash, or the like.

Preferably, the aluminium-containing feedstock comprises or consists of fly ash.

In some embodiments, the aluminium-containing feedstock may be an aluminosilicate. For instance, the aluminium-containing feedstock may be kaolin, zeolite, feldspar, or the like.

The aluminium-containing feedstock may be of any suitable form. Preferably, the aluminium-containing feedstock may be provided in the form of a solid material. In some embodiments, the aluminium-containing feedstock may be provided in granulated or particulate form.

In some embodiments, the aluminium-containing feedstock may undergo one or more preparation steps prior to subjecting the aluminium-containing feedstock to an alkali fusion process. Any suitable preparation steps may be used. For instance, the aluminium-containing feedstock may undergo a size reduction step. Similarly, the aluminium-containing feedstock may undergo a separation step (such as separation on the basis of particle size, density, or similar physical property) In a particular embodiment, the aluminium-containing feedstock may undergo a sieving step to obtain a desired particle size distribution.

As indicated, the aluminium-containing feedstock may be subjected to an alkali fusion process to provide an activated aluminium-containing feedstock.

Any suitable alkali fusion process may be used. Generally, the alkali fusion process may cause the activation of the aluminium-containing feedstock and/or improve aluminium recovery during subsequent process steps (such as, but not limited to, leaching). Advantageously, alkali fusion may cause non-reactive insoluble materials (such as mullite) found in solid waste residue from the combustion of coal or other organic materials to undergo a phase change into a more reactive soluble sodium aluminosilicate.

Preferably, the alkali fusion process comprises contacting the aluminium-containing feedstock with an alkali or alkaline earth reagent at elevated temperatures.

Any suitable alkali or alkaline earth reagent may be used. For instance, the alkali or alkaline earth reagent may comprise sodium hydroxide, potassium hydroxide, magnesium hydroxide, calcium hydroxide, calcium oxide, calcium carbonate, sodium carbonate, or the like, or any suitable combination thereof.

In a preferred embodiment, the alkali or alkaline earth reagent may be sodium hydroxide.

The alkali or alkaline earth reagent may be of any suitable form. For instance, the alkali or alkaline earth reagent may be provided in solid form (such as in the form of a powder, granules, flakes, pearls, pellets, or the like). Alternatively, an alkali or alkaline earth reagent solution may be provided.

In a preferred embodiment, the alkali or alkaline earth reagent may be in the form of pellets.

The alkali or alkaline earth reagent may be applied at any suitable application rate to the aluminium-containing feedstock. Generally, the application rate may vary depending on the form and/or concentration of the alkali or alkaline earth reagent and the type of aluminium-containing feedstock.

In some embodiments, the mass ratio of alkali or alkaline earth reagent to aluminium-containing feedstock may be about 10% w/w. about 20% w/w, about 30% w/w, about 40% w/w, about 50% w/w, about 60% w/w, about 70% w/w, about 80% w/w, about 90% w/w, about 100% w/w, or about 125% w/w.

Preferably, the mass ratio of alkali or alkaline earth reagent to aluminium-containing feedstock may be about 50% w/w to about 100% w/w.

For example, about 50% w/w sodium hydroxide pearls may be applied to fly ash. In another example, about 100% w/w sodium hydroxide pearls may be applied to fly ash.

The aluminium-containing feedstock may be contacted with an alkali or alkaline earth reagent in any suitable manner. It is envisaged, however, that the method of contacting the aluminium-containing feedstock with the alkali or alkaline earth reagent may be configured to maximise contact between the alkali or alkaline earth reagent and the surface of the aluminium-containing feedstock.

In some embodiments, the aluminium-containing feedstock may be dispersed within a solution of the alkali or alkaline earth reagent. In other embodiments, a solution of the alkali or alkaline earth reagent may be applied to the aluminium-containing feedstock (for instance, by spraying, coating, or the like). In other embodiments, the aluminium-containing feedstock and alkaline earth reagent may be mixed together to form a mixture.

Preferably, the aluminium-containing feedstock and the alkali or alkaline earth reagent may be mixed together to form a substantially homogenous mixture.

The aluminium-containing feedstock may be contacted with an alkali or alkaline earth reagent at any suitable temperature. For instance, the alkali fusion process may be conducted at a temperature of between about 400° C. and about 700° C., between about 425° C. and about 675° C., between about 450° C. and about 650° C., between about 500° C. and about 600° C., between about 525° C. and about 575° C.

Preferably, the aluminium-containing feedstock may be contacted with an alkali or alkaline earth reagent at a temperature of about 550° C. to provide an activated aluminium-containing feedstock.

The alkali fusion process may be carried out using any suitable equipment. For instance, the alkali fusion process may be performed in a rotary kiln, fluidised bed, calciner, or the like.

In some embodiments, the activated aluminium-containing feedstock may undergo a comminution process (or similar size reduction process) before being contacted with hydrochloric acid to obtain a leachate.

Any suitable size reduction or comminution process may be used, such as crushing, grinding, cutting, vibrating or the like. Generally, the process may be configured to reduce the particle size of the activated aluminium-containing feedstock and increase the surface area to be exposed to hydrochloric acid during leaching.

As indicated, the activated aluminium-containing feedstock may be contacted with hydrochloric acid to obtain a leachate.

The activated aluminium-containing feedstock may be contacted with the hydrochloric acid in any suitable manner. Generally, the method of contacting the activated aluminium-containing feedstock with the hydrochloric acid may be configured to effectively leach aluminium (and, in particular, a relatively high proportion of aluminium) from the activated aluminium-containing feed.

In some embodiments, the activated aluminium-containing feedstock and the hydrochloric acid may be mixed together to form a slurry.

Any suitable concentration of hydrochloric acid may be used. Generally, the concentration of hydrochloric acid may be sufficient to solubilise aluminium into solution.

In some embodiments, a hydrochloric acid solution may be used. In these embodiments, the hydrochloric acid solution may have a concentration of between about 5% and about 35% hydrochloric acid, between about 10% and about 30% hydrochloric acid, between about 15% and about 25 % hydrochloric acid. Preferably, the hydrochloric acid solution may have a concentration of about 20% hydrochloric acid. It will be understood that the volume of hydrochloric acid (or hydrochloric acid solution) required may vary depending on a number of factors, including the particle size and composition of the activated aluminium-containing feedstock and the level of impurities.

The addition of the hydrochloric acid to the activated aluminium-containing feedstock may form a mixture of any suitable pulp density. For example, the mixture may be between about 10% m/v and about 25% m/v pulp density.

Preferably, the activated aluminium-containing feedstock-hydrochloric acid mixture may be about 20% m/v pulp density.

The activated aluminium-containing feedstock-hydrochloric acid mixture may be held at any suitable temperature. However, it will be understood that the temperature may be elevated in order for the leaching process to be effective. The temperature may vary depending on a number of factors, such as whether the leaching is conducted under pressure, the leaching time and concentration of the hydrochloric acid as well as the composition and particle size of the activated aluminium-containing feedstock.

The activated aluminium-containing feedstock-hydrochloric acid mixture may be held at a leaching temperature of between about 40° C. and about 110° C. More preferably, the activated aluminium-containing feedstock-hydrochloric acid mixture may be held at a leaching temperature of between about 70° C. and about 90° C. In some embodiments, the activated aluminium-containing feedstock-hydrochloric acid mixture may be held at a leaching temperature of about 80° C.

The activated aluminium-containing feedstock-hydrochloric acid mixture may be held at a leaching temperature for any suitable period of time. However, it will be understood that the leaching time may vary depending on a number of factors such as whether the leaching is conducted under pressure, the leaching temperature and concentration of the hydrochloric acid as well as the composition and particle size of the activated aluminium-containing feedstock.

In a specific embodiment, the activated aluminium-containing feedstock may be contacted with a 20% solution of hydrochloric acid at a temperature of about 80° C. to obtain a leachate.

As indicated, the leachate may be separated to provide a pregnant liquor.

The leachate may be separated using any suitable technique. Preferably, the separation technique may be configured to separate the leachate into a pregnant liquor and a residue (in particular a solid residue). For instance, the separation technique may include gravity settling clarifiers, sedimentation, decanting, centrifugation, filtration, or the like.

In some embodiments, the pregnant liquor may be polished.

The pregnant liquor may be polished or clarified using any suitable technique. Preferably, the polishing step may be configured to remove or reduce suspended solids such as fine precipitate, insoluble material, or the like. In some embodiments, the pregnant liquor may be polished or clarified using a filtration process and/or through the addition of one or more flocculants.

As indicated, the pregnant liquor may be subjected to a sodium reduction process.

Any suitable sodium reduction process may be used. Preferably, however, the pregnant liquor may undergo a sodium reduction process prior to the step of subjecting the pregnant liquor to a crystallisation process. In use, it is envisaged that the sodium reduction process may result in the selective precipitation of aluminium hydroxide.

Preferably, the sodium reduction process may include adjusting a pH of the pregnant liquor to precipitate an aluminium hydroxide. The sodium reduction process may further include the step of separating the precipitated aluminium hydroxide from a spent liquor. The sodium reduction process may further include the step of contacting the precipitated aluminium hydroxide with hydrochloric acid to provide a reduced-sodium pregnant liquor.

The pH of the pregnant liquor may be adjusted to any suitable value. Generally, the pH of the pregnant liquor may be adjusted to provide favourable conditions for the selective precipitation of aluminium hydroxide. Preferably the pH of the pregnant liquor may be adjusted to an acidic pH. It is envisaged that, while the pH of the pregnant liquor may be an acidic pH, the pH may be adjusted by increasing the pH of the pregnant liquor.

In some embodiments, the pH of the pregnant liquor may be adjusted to a pH of between about 6 and about 7. Preferably, the pH of the pregnant liquor may be adjusted to a pH of about 6.5.

In some embodiments, the pH of the pregnant liquor may be adjusted using a basic substance, such as, but not limited to, ammonia.

Any suitable concentration of ammonia may be used. Generally, the concentration of ammonia may be selected so as to adjust the pH of the pregnant liquor to the desired value while minimising the volume of ammonia added.

For instance, the ammonia may have a concentration of between about 3 M and about 9 M, between about 4 M and about 8 M, or between about 5 M and about 7M. It will be understood that the volume of ammonia may vary depending on a number of factors, including the pH of the pregnant liquor and the composition of the leachate.

The pH adjustment step may be conducted at any suitable temperature and pressure.

Preferably, the pH adjustment step may be conducted at ambient temperature. As used herein, ambient temperature may include any temperature within the range of about 18° C. and about 25° C.

Preferably, the pH adjustment step may be conducted at atmospheric pressure.

The precipitated aluminium hydroxide may be separated from the spent liquor using any suitable technique. Generally, the separation technique may be configured to remove the spent liquor (including dissolved sodium) from the precipitated aluminium hydroxide. For instance, the separation technique may include gravity settling clarifiers, sedimentation, decanting, centrifugation, filtration, or the like, or any suitable combination thereof.

In some embodiments, the precipitated aluminium hydroxide may be washed after being separated from the spent liquor.

The precipitated aluminium hydroxide may be contacted with hydrochloric acid to generate a reduced-sodium pregnant liquor. In this instance, it will be understood that aluminium hydroxide reacts with the hydrochloric acid to produce aluminium chloride.

Any suitable concentration of hydrochloric acid may be used. Generally, the concentration of hydrochloric acid may be configured to solubilise aluminium into solution as aluminium chloride.

For instance, the hydrochloric acid may be provided in the form of a hydrochloric acid solution (such as an aqueous solution). The hydrochloric acid solution may have a concentration of between about 20% and about 40% hydrochloric acid. More preferably, the hydrochloric acid solution may have a concentration of between about 25% and about 35% hydrochloric acid. Most preferably, the hydrochloric acid solution may have a concentration of about 32% hydrochloric acid. It will be understood that the volume of hydrochloric acid solution used may vary depending on a number of factors, including the particle size and composition of the precipitated aluminium hydroxide and the level of impurities.

The addition of the hydrochloric acid (or hydrochloric acid solution) to the precipitated aluminium hydroxide may form a mixture of any suitable pulp density. For example, the mixture may be no more than about 25% m/v pulp density. More preferably, the mixture may be of no more than about 20% m/v pulp density. More preferably, the mixture may be of no more than about 15% m/v pulp density. Most preferably, the mixture may be of no more than about 10% m/v pulp density.

Preferably, the aluminium hydroxide-hydrochloric acid mixture may be about 10% m/v pulp density.

The aluminium hydroxide-hydrochloric acid mixture may be held at any suitable temperature. It is envisaged that the aluminium hydroxide-hydrochloric acid mixture may be held at a suitable temperature for use in a leaching process.

Preferably, the aluminium hydroxide-hydrochloric acid mixture may be held at an ambient temperature during leaching. As used herein, ambient temperature may include any temperature within the range of between about 18° C. and about 25° C.

Preferably, the leaching process using the aluminium hydroxide-hydrochloric acid mixture may be conducted at substantially atmospheric pressure.

In some embodiments, the precipitated aluminium hydroxide may be dewatered prior to contacting with the hydrochloric acid. The precipitated aluminium hydroxide may be dewatered using any suitable technique. For instance, the precipitated aluminium hydroxide may be dewatered using centrifugal separation, a screw press, a belt press, gravity settling, sedimentation, decanting, or the like, or any suitable combination thereof.

As indicated, the reduced-sodium pregnant liquor may be subjected to a crystallisation process to form an aluminium chloride hexahydrate crystals slurry.

Any suitable crystallisation process may be used. Generally, the crystallisation process may be configured to precipitate the aluminium chloride hexahydrate crystals from the reduced-sodium pregnant liquor and/or to minimise the precipitation of impurities.

For instance, the crystallisation process may include sparging the reduced-sodium pregnant liquor (such as with gaseous hydrochloric acid) to produce crystallisation, and to form a slurry of aluminium chloride hexahydrate crystals.

In some embodiments, the crystallisation process may include evaporative crystallisation.

In some embodiments, the aluminium chloride hexahydrate crystal slurry may be subjected to one or more recrystallisation processes. It is envisaged that a recrystallisation process may be performed on crystals formed from a crystallisation method in order to reduce or remove impurities in the compound produced from crystallisation.

In this instance, it is envisaged that aluminium chloride hexahydrate crystal slurry obtained from the crystallisation of the reduced-sodium pregnant liquor may be subjected to one or more recrystallisation steps before the aluminium chloride hexahydrate crystals are separated from the aluminium chloride hexahydrate crystal slurry.

The slurry of aluminium chloride hexahydrate crystals may be recrystallised using any suitable technique.

For example, the recrystallisation process may comprise separating and washing the precipitated crystals. Further, the recrystallisation process may comprise dissolving the washed precipitated crystals in a solvent (such as ultra-pure water, demineralised water, or the like) to form a feed liquor. The feed liquor may undergo a polishing step to remove insoluble contaminants such as silica. The feed liquor may be sparged (such as with gaseous hydrochloric acid) to precipitate aluminium chloride hexahydrate crystals.

As indicated, the aluminium chloride hexahydrate crystals slurry may undergo a separation process to obtain aluminium chloride hexahydrate crystals.

The aluminium chloride hexahydrate crystals slurry may be separated from the spent liquor using any suitable technique. Preferably, the separation technique may be configured to separate the aluminium chloride hexahydrate crystals from a spent liquor. In some embodiments, the separation technique may include the use of gravity settling clarifiers, sedimentation, decanting, centrifugation, filtration, or the like, or any suitable combination thereof.

In some embodiments, the aluminium chloride hexahydrate crystals may undergo one or more further processing steps. For instance, the aluminium chloride hexahydrate crystals may undergo a recrystallisation step to increase the purity of the crystals, may be at least partially dried, may undergo a decomposition step to form an intermediate alumina precursor, or the like, or a combination thereof.

In some embodiments, the method for producing an aluminous material according to the first aspect of the invention may further include washing the activated aluminium-containing feedstock and separating the washed activated aluminium-containing feedstock from the wash liquid.

Preferably, the activated aluminium-containing feedstock may be washed before the step of contacting the activated aluminium-containing feedstock with hydrochloric acid (or a hydrochloric acid solution) to obtain a leachate. In use, it is envisaged that washing the activated aluminium-containing feedstock may assist in reducing sodium levels prior to the leaching step.

In some embodiments, the method for producing an aluminous material comprises two sodium reduction processes.

The activated aluminium-containing feedstock may be washed with any suitable wash liquid. Generally, the wash liquid may be configured to solubilise the residual alkali or alkaline metal reagent from the alkali fusion process without leaching aluminium from the activated aluminium-containing feedstock.

In some embodiments, the wash liquid may be water, ultra-pure water, demineralised water, or the like.

In some embodiments, the washed activated aluminium-containing feedstock may be dewatered prior to contacting the activated aluminium-containing feedstock with hydrochloric acid. In this instance, it will be understood that the dewatering process may assist in removing additional contaminated liquor from the process. Any suitable dewatering process may be used, such as centrifugal separation, a screw press, a belt press, gravity settling, sedimentation, decanting, or the like, or any suitable combination thereof.

Preferably, the method for producing an aluminous material further includes calcining the aluminium chloride hexahydrate crystals to obtain alumina.

The aluminium chloride hexahydrate crystals may be calcined (for example, by means of a rotary kiln, fluidised bed, calciner, etc.) at a relatively high temperature in order to obtain alumina. Preferably, the alumina obtained may comprise substantially alpha alumina.

The aluminium chloride hexahydrate crystals may be calcined at any suitable temperature. Generally, the calcination temperature may be configured to at least partially convert the aluminium chloride hexahydrate crystals to alpha alumina. However, a person skilled in the art will appreciate that the calcination temperature may vary depending on a number of factors, including the residence time in the calciner, equipment capability, and sintering temperature.

The aluminium chloride hexahydrate crystals may be heated to a calcination temperature of between about 950° C. and about 1,300° C., and more preferably between about 1,100° C. and about 1,300° C.

In some embodiments, the aluminium chloride hexahydrate crystals may be heated to a calcination temperature of between about 1,100° C. and about 1,300° C.

The aluminium chloride hexahydrate crystals may be heated to a calcination temperature for any suitable period of time.

For instance, the aluminium chloride hexahydrate crystals may be heated to a calcination temperature for a period of at least about 30 minutes. More preferably, the aluminium chloride hexahydrate crystals may be heated to a calcination temperature for a period of at least 60 minutes. More preferably, the aluminium chloride hexahydrate crystals may be heated to a calcination temperature for a period of at least about 90 minutes. More preferably, the aluminium chloride hexahydrate crystals may be heated to a calcination temperature for a period of at least about 2 hours. More preferably, the aluminium chloride hexahydrate crystals may be heated to a calcination temperature for a period of at least about 3 hours. More preferably, the aluminium chloride hexahydrate crystals may be heated to a calcination temperature for a period of at least about 4 hours.

In some embodiments, the aluminium chloride hexahydrate crystals may be subjected to a decomposition step before the step of calcining the aluminium chloride hexahydrate crystals to provide alumina. In this instance, it will be understood that a preliminary decomposition process may produce transition alumina phases and amorphous alumina which during calcination are subsequently converted to alpha alumina.

The aluminium chloride hexahydrate crystals may be decomposed at any suitable temperature and using any suitable technique. Generally, the decomposition temperature may be configured to remove remaining chlorides. However, a person skilled in the art will appreciate that the decomposition temperature may vary depending on a number of factors, including the decomposition time, the heat transfer rate, the particle size of the aluminium chloride hexahydrate crystals, and whether the vessel is agitated.

The aluminium chloride hexahydrate crystals may be heated to a decomposition temperature of between about 600° C. and about 1,200° C., more preferably between about 700° C. and about 1,100° C., and more preferably between about 800° C. and about 1,000° C.

In some embodiments, the aluminium chloride hexahydrate crystals may be heated to a decomposition temperature of about 800° C.

The aluminium chloride hexahydrate crystals may be heated to a decomposition temperature for any suitable period of time.

In some embodiments, the aluminium chloride hexahydrate crystals may be heated to a decomposition temperature for a period of at least about 30 minutes. More preferably, the aluminium chloride hexahydrate crystals may be heated to a decomposition temperature for a period of at least about 60 minutes. More preferably, the aluminium chloride hexahydrate crystals may be heated to a decomposition temperature for a period of at least about 90 minutes. More preferably, the aluminium chloride hexahydrate crystals may be heated to a decomposition temperature for a period of at least about 2 hours. More preferably, the aluminium chloride hexahydrate crystals may be heated to a decomposition temperature for a period of at least about 3 hours. More preferably, the aluminium chloride hexahydrate crystals may be heated to a decomposition temperature for a period of at least about 4 hours. More preferably, the aluminium chloride hexahydrate crystals may be heated to a decomposition temperature for a period of at least about 5 hours. More preferably, the aluminium chloride hexahydrate crystals may be heated to a decomposition temperature for a period of at least about 6 hours.

In use, it is envisaged that splitting the calcination process into a lower temperature decomposition stage and a higher temperature calcination stage may effectively split the process across two pieces of equipment that can each be designed for a more specific range of operating conditions. This may in turn reduce the stress placed on each piece of equipment, reducing maintenance requirements and the chance of potential equipment failure.

In some embodiments, the step of decomposing the aluminium chloride hexahydrate crystals may comprise controlling the humidity in the vessel. In use, it is envisaged that controlling the humidity of the vessel may assist in promoting chloride removal prior to the calcination step.

In use, it is envisaged that lowering the residual chloride levels of the transition alumina phases may reduce a potential cause of corrosion in the vessel during calcination. As a result, this may allow a wider selection of materials to be used in the construction of the vessels, kilns, calciners, and the like in which the pyrolysis occurs.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method of producing an aluminous material according to an embodiment of the invention; and

FIG. 2 illustrates a method of producing an aluminous material according to an embodiment of the invention.

### DETAILED DESCRIPTION

Unless defined otherwise, all technical and scientific terms used herein have the same meaning as would be commonly understood by those of ordinary skill in the art to which this invention belongs.

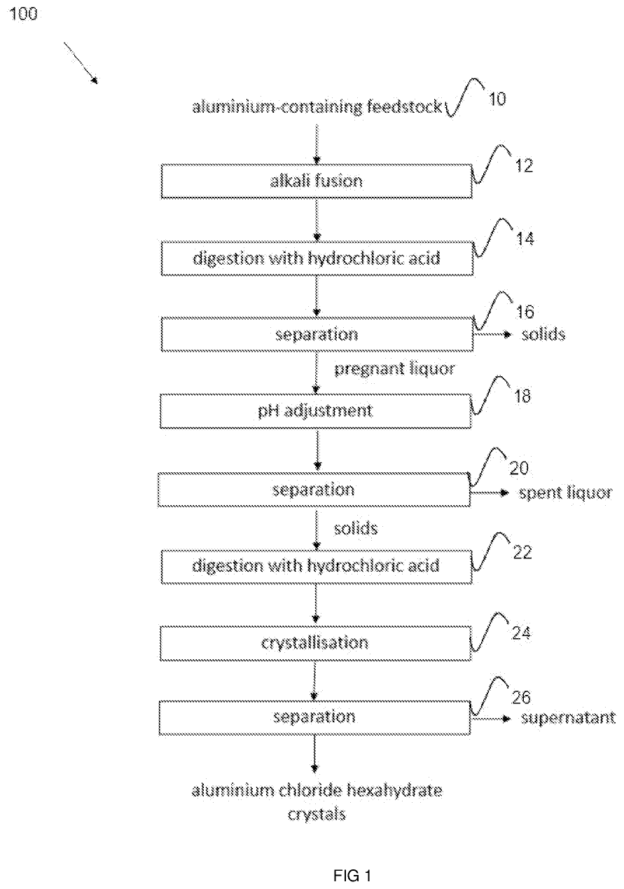

A method (100) for producing an aluminous material as shown in FIG. 1 is now described in detail. Preferably, the aluminous material comprises aluminium chloride hexahydrate.

At step 10, an aluminium-containing feedstock may be provided.

Any suitable type of aluminium-containing feedstock may be used.

In some embodiments, the aluminium-containing feedstock may be fly ash, boiler ash, boiler slag, bottom ash, or the like. In other embodiments, the aluminium-containing feedstock may be an aluminosilicate such as kaolin, zeolite, feldspar, or the like.

Preferably, the aluminium-containing feedstock may be fly ash.

At step 12, the aluminium-containing feedstock is subjected to an alkali fusion process to provide an activated aluminium-containing feedstock.

Preferably, the alkali fusion process comprises contacting the aluminium-containing feedstock with an alkali or alkaline earth reagent at elevated temperatures.

Any suitable alkali or alkaline earth reagent may be used. For instance, the alkali or alkaline earth reagent may comprise sodium hydroxide, potassium hydroxide, magnesium hydroxide, calcium hydroxide, calcium oxide, calcium carbonate, sodium carbonate, or the like.

Preferably, the alkali or alkaline earth reagent may be sodium hydroxide.

Preferably, the aluminium-containing feedstock may be contacted with an alkali or alkaline earth reagent at a temperature of about 550° C. to provide an activated aluminium-containing feedstock.

Preferably, the activated aluminium-containing feedstock may undergo a size reduction or comminution process before being contacted with hydrochloric acid to obtain a leachate.

At step 14, the activated aluminium-containing feedstock is contacted with a hydrochloric acid to obtain a leachate.

Preferably, the activated aluminium-containing feedstock may be contacted with a 20% solution of hydrochloric acid at a temperature of about 80° C. to obtain a leachate.

Preferably, the activated aluminium-containing feedstock-hydrochloric acid mixture may be about 20% m/v pulp density.

At step 16, the leachate is separated to provide a pregnant liquor.

The pregnant liquor is subjected to a sodium reduction process (steps 18, 20, and 24). Advantageously, subjecting the pregnant liquor to a sodium reduction process enables the production of higher purity aluminium chloride hexahydrate crystals during subsequent crystallisation stages with lower levels of mixed aluminium-sodium chlorides.

At step 18, the pH of the pregnant liquor is adjusted to precipitate an aluminium hydroxide.

Preferably, the pH of the pregnant liquor may be adjusted to a pH of about 6.5. Preferably, the pH of the pregnant liquor may be adjusted using ammonia.

At step 20, the precipitated aluminium hydroxide is separated from a spent liquor.

At step 22, the precipitated aluminium hydroxide is contacted with hydrochloric acid to provide a reduced-sodium pregnant liquor.

Preferably, the precipitated aluminium hydroxide may be contacted with a 32% Preferably, the aluminium hydroxide-hydrochloric acid mixture may be about 10% m/v pulp density.

Preferably, the aluminium hydroxide-hydrochloric acid mixture may be held at an ambient temperature during leaching, that is, at a temperature of between about 18° C. and about 25° C.

At step 24, the reduced-sodium pregnant liquor is subjected to a crystallisation process to form an aluminium chloride hexahydrate crystals slurry.

At step 26, the aluminium chloride hexahydrate crystals slurry is separated to obtain aluminium chloride hexahydrate crystals.

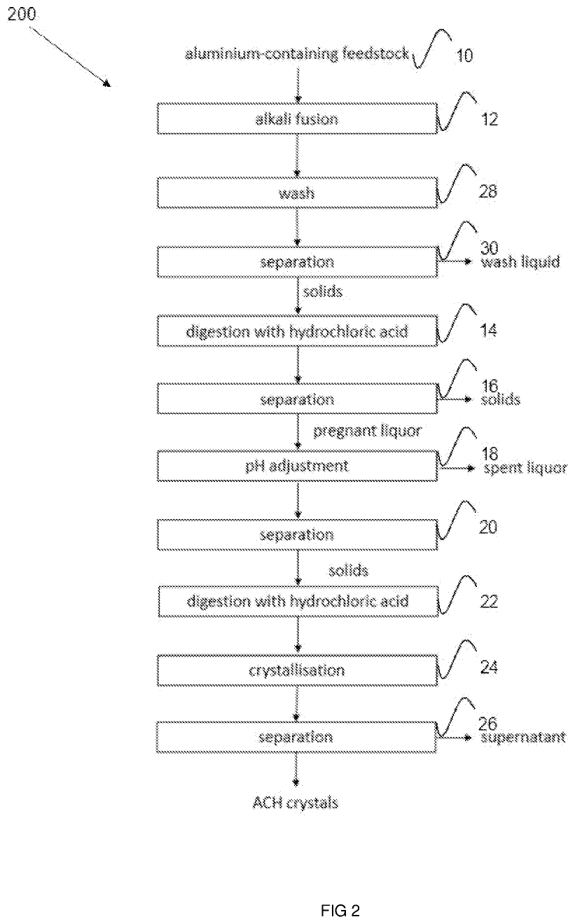

A method (200) for producing an aluminous material as shown in FIG. 2 is now described in detail. Preferably, the aluminous material comprises aluminium chloride hexahydrate. The method as illustrated in FIG. 2 and described in the specification is the same as the method illustrated in FIG. 1 and described in the specification with the exception that the activated aluminium-containing feedstock is subjected to additional processing steps 28 and 30.

Steps 10, 12, 14, 16, 18, 20, 22, 24, and 26 in the method as illustrated in FIG. 2 correspond to steps 10, 12, 14, 16, 18, 20, 22, 24, and 26 in the method as illustrated in FIG. 1.

Prior to contacting the activated aluminium-containing feedstock with hydrochloric acid to obtain a leachate at step 14, the activated aluminium-containing feedstock may be subjected to a subjected to a sodium reduction process (steps 28 and 30). Advantageously, washing the activated aluminium-containing feedstock may assist in reducing sodium levels prior to the leaching step.

At step 28, the activated aluminium-containing feedstock is washed.

At step 30, the washed activated aluminium-containing feedstock is separated from the wash liquid.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for producing an aluminous material including:
providing an aluminium-containing feedstock;
subjecting the aluminium-containing feedstock to an alkali fusion process to generate an activated aluminium-containing feedstock;
contacting the activated aluminium-containing feedstock with hydrochloric acid to obtain a leachate;
separating the leachate to generate a pregnant liquor;
subjecting the pregnant liquor to a sodium reduction process, the sodium reduction process including:
adjusting a pH of the pregnant liquor to precipitate an aluminium hydroxide;
separating the precipitated aluminium hydroxide from a spent liquor, and
contacting the precipitated aluminium hydroxide with hydrochloric acid to provide a reduced-sodium pregnant liquor,
subjecting the reduced-sodium pregnant liquor to a crystallisation process to form an aluminium chloride hexahydrate crystals slurry, and
separating the aluminium chloride hexahydrate crystals slurry to obtain aluminium chloride hexahydrate crystals.

2. The method according to claim 1, wherein the aluminium-containing feedstock comprises a waste residue from combustion of coal or other organic material, or an incinerator waste.

3. The method according to claim 1, wherein the aluminium-containing feedstock comprises or consists of fly ash.

4. The method of claim 1, wherein the aluminium-containing feedstock comprises an aluminosilicate.

5. The method of claim 1, wherein the aluminium-containing feedstock undergoes one or more preparation steps prior to subjecting the aluminium-containing feedstock to the alkali fusion process.

6. The method according to claim 5, wherein the one or more preparation steps comprises a size reduction step.

7. The method of claim 1, wherein the alkali fusion process comprises contacting the aluminium-containing feedstock with an alkali or alkaline earth reagent at an elevated temperature.

8. The method according to claim 7, wherein the alkali or alkaline earth reagent comprises sodium hydroxide.

9. The method according to claim 7, wherein the aluminium-containing feedstock and the alkali or alkaline earth reagent are mixed together to form a substantially homogenous mixture.

10. The method according to claim 7, wherein the elevated temperature is between about 500° C. and about 600° C.

11. The method of claim 1, wherein the activated aluminium-containing feedstock undergoes a comminution process before being contacted with hydrochloric acid to obtain the leachate.

12. The method of claim 1, wherein the hydrochloric acid is provided in the form of a hydrochloric acid solution.

13. The method of claim 1, wherein the activated aluminium-containing feedstock and the hydrochloric acid are mixed together to form a slurry.

14. The method according to claim 13, wherein the slurry is held at a temperature of between about 70° C. and about 90° C.

15. The method of claim 1, wherein the leachate is separated into the pregnant liquor and a residue.

16. The method of claim 1, wherein the pregnant liquor is polished or clarified.

17. The method of claim 1, wherein the pH of the pregnant liquor is adjusted to a pH of between about 6 and about 7.

18. The method according to claim 17, wherein the pH of the pregnant liquor is adjusted using ammonia.

19. The method of claim 1, wherein the pH of the pregnant liquor is adjusted at ambient temperature.

20. The method of claim 1, further including washing the activated aluminium-containing feedstock, and
separating the washed activated aluminium-containing feedstock from the wash liquid,
wherein the activated aluminium-containing feedstock is washed to remove excess sodium before contacting the activated aluminium containing feedstock with hydrochloric acid to obtain a leachate.

21. A method for producing an aluminous material according to claim 1, further including calcining the aluminium chloride hexahydrate crystals to obtain primarily alpha alumina.

22. The method of claim 1, further including subjecting the aluminium chloride hexahydrate crystals slurry to one or more recrystallisation processes before the aluminium chloride hexahydrate crystals slurry is separated to obtain aluminium chloride hexahydrate crystals.
